(19) United States
(12) Patent Application Publication
(10) Pub. No.: US 2026/0093202 A1
(43) Pub. Date: Apr. 2, 2026

(54) FIXING APPARATUS

(71) Applicant: CANON KABUSHIKI KAISHA, Tokyo (JP)

(72) Inventors: GOSHI OZAKI, Kanagawa (JP); TAKASHI KIMURA, Tokyo (JP); EITA KAWASAKI, Kanagawa (JP); MIKA MAEJIMA, Tokyo (JP); MASAFUMI MAEDA, Kanagawa (JP); KENICHI TAGAMI, Tokyo (JP)

(21) Appl. No.: 19/330,546

(22) Filed: Sep. 16, 2025

(30) Foreign Application Priority Data
Oct. 2, 2024 (JP) 2024-173031

(51) Int. Cl. G03G 15/00; G03G 15/20

(52) U.S. Cl. CPC G03G 15/80; G03G 15/2053; G03G 15/2064; G03G 2215/2035

(57) ABSTRACT

A fixing apparatus that is installed in an image forming apparatus, the image forming apparatus including a main body conductor portion, the fixing apparatus includes a heating unit including an endless belt and a heater, a pressure roller configured to form a nip portion together with the heater via the belt, a pressure arm, a pressure spring configured to bias the pressure arm, the pressure spring having electroconductivity, a frame configured to support the heating unit and made of resin, a brush member configured to contact the belt, a first conductor portion configured to contact and electrically connect the brush member and the pressure spring, and a second conductor portion configured to contact and electrically connect the pressure spring and the main body conductor portion.

### BACKGROUND

### Field of the Technology

The present disclosure relates to a fixing apparatus provided in an electrophotographic image forming device.

### Description of the Related Art

The fixing apparatus discussed in Japanese Patent Laid-Open No. 2024-31208 includes a heating unit that includes a heater to heat the inner surface of a belt and a pressure roller that forms a nip portion with the heater via the belt to fix toner on a recording material.

### SUMMARY

The present disclosure is directed to providing a fixing apparatus in a new form that has advanced the conventional technology.

Various aspects of the present disclosure are described herein.

An aspect of the present disclosure provides a fixing apparatus configured to be installed in an image forming apparatus to fix toner to a recording material, the image forming apparatus including a main body conductor portion capable of electrical grounding, with the fixing apparatus including a heating unit including an endless belt and a heater that is disposed inside the belt to heat the belt, a pressure roller configured to form a nip portion together with the heater via the belt, a pressure arm configured to press the heating unit against the pressure roller, a pressure spring configured to bias the pressure arm to press the heating unit against the pressure roller, the pressure spring having electroconductivity, a frame configured to support the heating unit and made of resin, a brush member configured to contact the belt and that has electroconductivity, a first conductor portion configured to contact and electrically connect the brush member and the pressure spring, and a second conductor portion configured to contact and electrically connect the pressure spring and the main body conductor portion.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are perspective views each illustrating a fixing apparatus according to a first embodiment.

FIG. 2 is a cross-sectional view of an image forming device according to the first embodiment.

FIG. 3 is a cross-sectional view of the fixing apparatus according to the first embodiment.

FIG. 4 is a cross-sectional view of the fixing apparatus according to the first embodiment.

FIG. 5 is an exploded perspective view of the fixing apparatus according to the first embodiment.

FIGS. 6A and 6B are perspective views each illustrating the fixing apparatus according to the first embodiment.

FIG. 7 is a top view of the fixing apparatus according to the first embodiment.

FIG. 8 is a perspective view of the fixing apparatus according to the first embodiment.

FIG. 9 is a cross-sectional view of the fixing apparatus according to the first embodiment.

FIGS. 10A and 10B are a front view and a plan view of a contact spring according to the first embodiment, respectively.

FIG. 11A is a front view illustrating the fixing apparatus and FIGS. 11A to 11D are cross-sectional views each illustrating the fixing apparatus according to the first embodiment, respectively.

FIGS. 12A and 12B are cross-sectional views each illustrating the fixing apparatus according to the first embodiment.

FIG. 13 is an exploded perspective view of the fixing apparatus according to the first embodiment.

FIG. 14 is a top view of the fixing apparatus according to the first embodiment.

FIG. 15 is a top view of a fixing apparatus according to a first modification.

FIGS. 16A and 16B are schematic diagrams each illustrating a fixing apparatus according to a second modification.

### DESCRIPTION OF THE EMBODIMENTS

An embodiment (a first embodiment) of the present disclosure will now be described with reference to the drawings. Dimensions, materials, shapes, and relative positions of components in the following embodiment may be changed as appropriate depending on the configuration and the various conditions of the device to which the present disclosure is applied. Thus, unless otherwise specified, the scope of the present disclosure is not limited to the present embodiment.

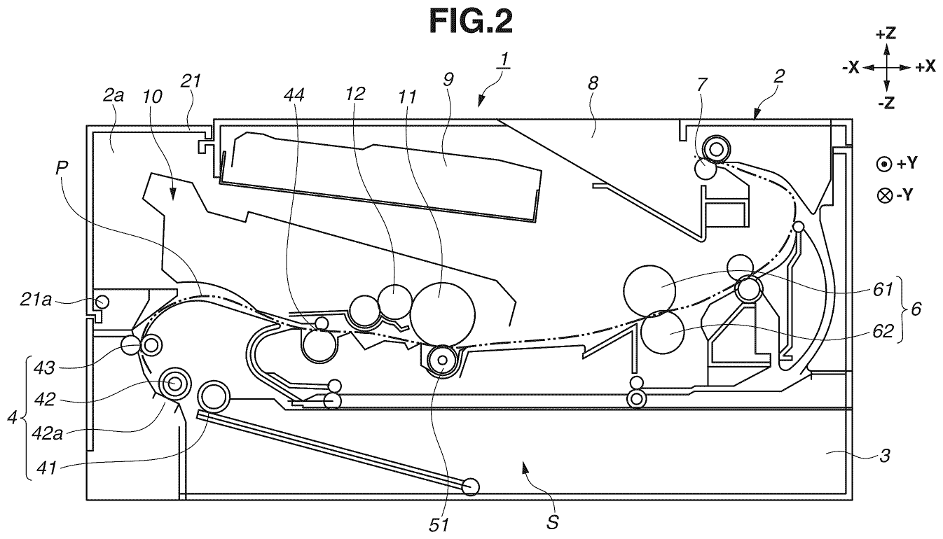

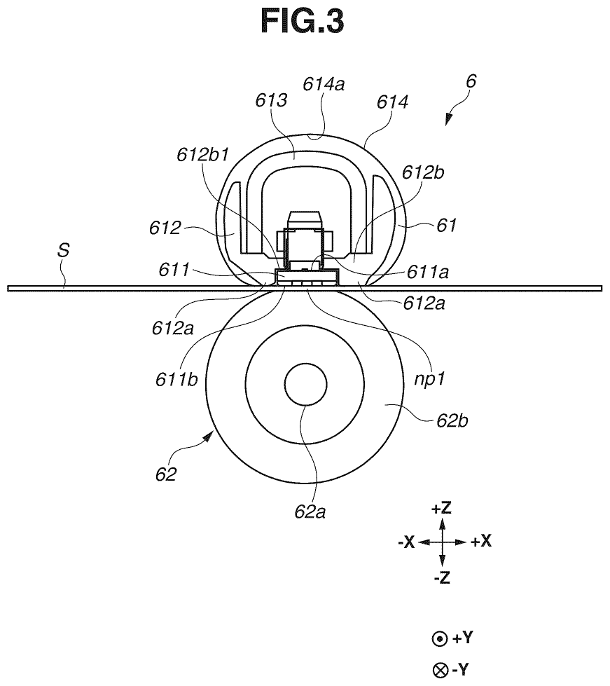

FIG. 2 is a cross-sectional view of an electrophotographic image forming device 1 to which a fixing apparatus of the present embodiment is applied. In the following description, as illustrated in FIG. 2, vertical directions in which the image forming device 1 is installed on a horizontal plane will be defined as Z directions (FIG. 3). Directions intersecting the Z directions will be defined as Y directions. The Y directions are parallel to the rotational axis line direction of a pressure arm 652 described below. The directions intersecting both the Z directions and the Y directions will be defined as X directions. The X directions are parallel to the direction in which a heating unit 61 described below conveys a recording material positioned at a nip portion. The X directions and the Y directions can be horizontal directions. The X directions, the Y directions, and the Z directions are mutually orthogonal. As necessary, directions of arrows x, y, and z illustrated in each drawing are respectively represented as the +x side, the +y side, and the +z side, and the opposite directions are respectively represented as the −x side, the −y side, and the −z side. In the following description, the direction in which a recording material is conveyed at a nip portion np1 described below will be referred to as a recording material conveying direction (the +X direction). The rotational axis line direction of the pressure arm 652 described below will be referred to as an axial direction. In the axial direction, the direction from the heating unit 61 described below toward an electrical contact 668b1 will be referred to as a first axial direction (the +Y direction). In the axial direction, the direction opposite to the first axial direction will be referred to as a second axial direction (the −Y direction). A Y direction is also a longitudinal direction of the heating unit 61. A Y direction is a generatrix direction of a belt 614.

### First Embodiment

A fixing unit 6 according to the first embodiment will be described.

### Configuration of Image Forming Device

A configuration of the image forming device 1 will be described with reference to FIG. 2. The image forming device 1 includes an apparatus main body 2, a process cartridge 10, and a fixing unit 6. The process cartridge 10 is detachably attached to the device main body 2. The fixing unit 6 is detachably attached to the apparatus main body 2. It can also be said that the fixing unit 6 is installed in the apparatus main body 2. The fixing unit 6 may be attached in a non-detachable manner.

The apparatus main body 2 includes a paper feed tray 3, a sheet feeding unit 4, a conveyance path P, a transfer roller 51, a sheet discharge unit 7, a paper discharge tray 8, a laser scanner 9, and an opening and closing door 21. The process cartridge 10 includes a photosensitive drum 11, and a development roller 12 as a developer carrier. The process cartridge 10 also contains developer therein. The opening and closing door 21 is pivotably supported around a pivot shaft 21a, and is movable between a closed position where an opening portion 2a is closed and an opened position where the opening portion 2a is opened. When the opening and closing door 21 is at the opened position where the opening portion 2a is opened, the process cartridge 10 can be attached to and detached from the apparatus main body 2 via the opening portion 2a.

The sheet feeding unit 4 includes a paper feed roller 41, a separation roller 42, a separation pad 42a, and a pair of conveyance rollers 43. A sheet S stored in the paper feed tray 3 is fed to the conveyance path P by the sheet feeding unit 4 based on a print start signal and is conveyed toward the transfer roller 51 via a pair of registration rollers 44.

Upon conveyance of the sheet S to a predetermined position, an image formation start signal is issued to start an image formation process. The photosensitive drum 11, which is rotationally driven by a driving source (a motor), is uniformly charged to a predetermined potential by a charging unit. The charged surface of the photosensitive drum 11 is exposed to light emitted by the laser scanner 9 based on image information, forming an electrostatic latent image from which the charge of the exposed portion is removed. The toner in the process cartridge 10 is carried by the development roller 12 and supplied to the photosensitive drum 11 based on the electrostatic latent image to develop the latent image. As a result, the latent image is visualized on the photosensitive drum 11 as a toner image.

The transfer roller 51 is arranged opposite to the photosensitive drum 11 of the process cartridge 10. When the sheet S conveyed by the pair of registration rollers 44 passes through the nip portion between the photosensitive drum 11 and the transfer roller 51, a voltage is applied from the apparatus main body 2 to the transfer roller 51, so that the toner image on the photosensitive drum 11 is transferred to the sheet S as an unfixed image. Thereafter, the sheet S with the toner image transferred thereto is conveyed to the fixing unit 6 including the heating unit 61 and a pressing rotation member 62. The fixing unit 6 is a fixing apparatus that fixes toner (developer) to a recording material. When the sheet S passes through the nip between the heating unit 61 and the pressing rotation member 62, the unfixed image having been transferred to the sheet S is heated and pressed to be fixed to the surface of the sheet S. The sheet S with the toner image fixed thereto is discharged to the paper discharge tray 8 through the sheet discharge unit 7.

### Configuration of Fixing Unit

A configuration of the fixing unit 6 will now be described. FIG. 3 is a plan view of the fixing unit 6. As illustrated in FIG. 3, the heating unit 61 includes a heater 611, a holder 612, a stay 613, and the belt 614. The heater 611 is disposed inside the belt 614 to heat the belt 614. The heater 611 extends in a generatrix direction (a Y direction) of the belt 614, and has a flat-plate shape. The heater 611 has a first surface 611a and a second surface 611b opposite to the first surface 611a, and the first surface 611a is supported by the holder 612.

The holder 612 is made of a heat-resistant resin, such as polyphenylene sulfide (PPS) or liquid crystal polymer, and has a guide surface 612a and a support wall 612b. The guide surface 612a contacts an inner peripheral surface 614a of the belt 614 to guide the belt 614, and the support wall 612b has a support surface 612b1 that supports the heater 611. The support surface 612b1 of the support wall 612b is in contact with the first surface 611a of the heater 611. The stay 613 is a member that supports the holder 612, and is formed by bending a plate material greater in rigidity than the holder 612, for example, a steel plate with a thickness of 1.6 mm, into substantially a U-shape.

The belt 614 is an endless belt having heat resistance and flexibility, and is formed, for example, of a metal sleeve, such as stainless steel, coated with fluororesin, or a laminate structure composed of polyimide resin, silicone rubber, fluororesin, and the like. The heater 611, the holder 612, and the stay 613 are arranged inside the belt 614, and the belt 614 is configured to rotate around those components. The inner peripheral surface 614a of the belt 614 contacts the second surface 611b of the heater 611.

The pressing rotation member 62 (a pressure roller) has a metallic shaft 62a and a roller 62b made of an elastic body covering the shaft 62a, and is pressed against the heater 611 via the belt 614. The pressing rotation member 62 and the heater 611 form the nip portion np1 to nip the sheet S for applying heat and pressure with the belt 614 interposed between the pressing rotation member 62 and the heater 611. That is, the pressing rotation member 62 (the pressure roller) forms the nip portion np1 together with the heater 611 via the belt 614. Thus, the pressing rotation member 62 heats and presses the sheet S together with the heater 611 at the nip portion np1.

The pressing rotation member 62 is configured to be rotated by a driving force transmitted from the driving source included in the image forming device 1. The belt 614 is rotated following the rotation of the pressing rotation member 62. The sheet S with the toner image transferred thereto is conveyed between the pressing rotation member 62 and the heated belt 614 to thermally fix the toner image.

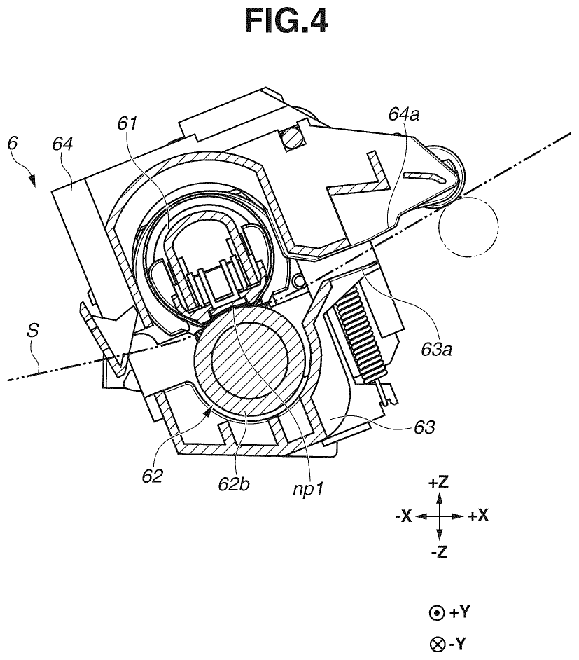

A frame configuration of the fixing unit 6 will now be described with reference to FIG. 4. FIG. 4 is a plan view of the fixing unit 6. The fixing unit 6 includes an upper frame 64 and a lower frame 63. The lower frame 63 can also be referred to as a first frame, and the upper frame 64 as a second frame. The lower frame 63 is a frame that supports the heating unit 61 and the pressing rotation member 62. The upper frame 64 is positioned above the lower frame 63 and covers the heating unit 61. The lower frame 63 and the upper frame 64 are resin members formed of non-conductive molded members (resin members). The upper frame 64 has an upper guide surface 64a positioned downstream of the heating unit 61 in the recording material conveying direction (the +X direction). The upper guide surface 64a guides the upper surface of the sheet S conveyed in the recording material conveying direction. The lower frame 63 has a lower guide surface 63a positioned downstream of the heating unit 61 in the recording material conveying direction. The lower guide surface 63a guides the lower surface of the sheet S conveyed in the recording material conveying direction.

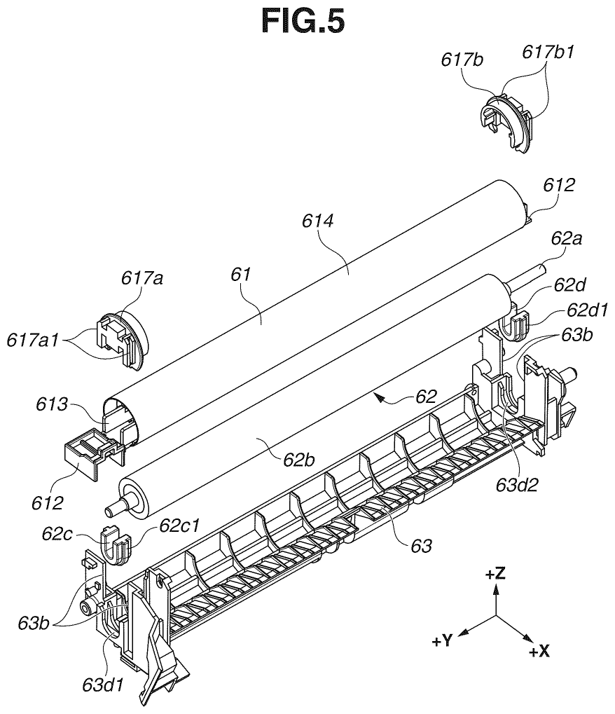

A configuration of the lower frame 63 that supports the pressing rotation member 62 will now be described with reference to FIG. 5. FIG. 5 is an exploded perspective view of the fixing unit 6. The lower frame 63 has rails 63b at the ends in the first axial direction and the second axial direction. The rails 63b extend in the vertical direction and support the holder 612 so as to be movable in the vertical direction. The two rails 63b face each other and engage with grooves 617a1 and 617b1 provided in transmission members 617a and 617b, respectively.

The fixing unit 6 includes bearings 62c and 62d. The end of the shaft 62a in the first axial direction and the end of the shaft 62a in the second axial direction are supported by the bearings 62c and 62d, respectively. The bearing 62c is positioned by being fitted into a recess 63d1 provided in the lower frame 63. Similarly, the bearing 62d is positioned by being fitted into a recess 63d2 provided in the lower frame 63. The bearing 62c has electroconductivity. In this configuration, the bearings 62c and 62d are provided with projections, and the lower frame 63 is provided with recesses 63d1 and 63d2, corresponding to the projections. In an embodiment, the projection-recess relationship may be reversed. The configuration for fixing the bearings 62c and 62d to the lower frame 63 is not limited to a projection-recess configuration.

### Configuration of Pressure Mechanisms

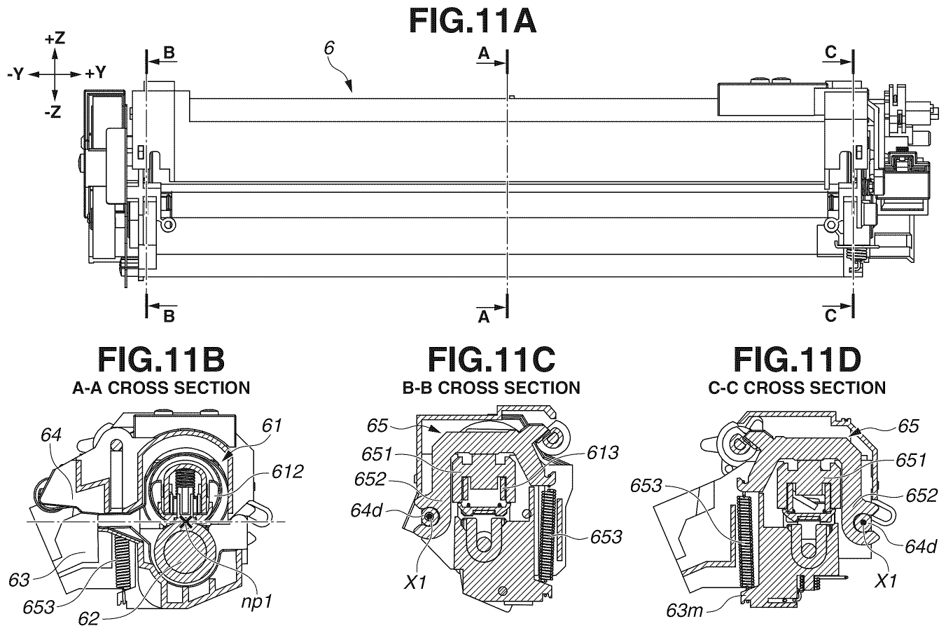

A configuration of pressure mechanisms of the fixing unit 6 will now be described. FIG. 11A is a front view of the fixing unit 6. FIGS. 11B to 11D are cross-sectional views of FIG. 11A.

As illustrated in FIGS. 11A to 11D, the fixing unit 6 has pressure mechanisms 65 that press the heating unit 61 against the pressing rotation member 62. The pressure mechanisms 65 are provided at the end of the lower frame 63 in the first axial direction and at the end of the lower frame 63 in the second axial direction. Thus, it can also be said that the pressure mechanisms 65 are supported by the lower frame 63. The pressure mechanism 65 provided at the end of the lower frame 63 in the first axial direction and the pressure mechanism 65 provided at the end of the lower frame 63 in the second axial direction have substantially the same structure. The description of the pressure mechanism 65 provided on the first axial direction side also applies to the pressure mechanism 65 provided on the second axial direction side. Thus, for conciseness, the description of the pressure mechanism 65 provided on the second axial direction side is incorporated by reference without being repeated.

Each pressure mechanism 65 includes a transmission member 651, a pressure arm 652, and a pressure spring 653. The pressure arm 652 is supported by the lower frame 63. More specifically, the pressure arm 652 is supported by a support portion 64d of the lower frame 63 so as to be rotatable around a center axis x1 of the support portion 64d. The support portion 64d is a substantially cylindrical projection.

The pressure arm 652 presses the transmission member 651 from above to move the transmission member 651 downward. Consequently, the transmission member 651 presses the stay 613 downward. The transmission member 651 presses the stay 613 to move the stay 613 downward. As the stay 613 moves downward, the heating unit 61 including the stay 613 is pressed toward the pressing rotation member 62. The pressure spring 653 is a conductive tension coil spring that biases the pressure arm 652 so that the heating unit 61 is pressed against the pressing rotation member 62. The pressure spring 653 is engaged with the lower frame 63 and the pressure arm 652. As the pressure spring 653 biases the pressure arm 652, the pressure arm 652 moves the transmission member 651 downward. Thus, the pressure arm 652 presses the heating unit 61 against the pressing rotation member 62 (the pressure roller).

### Configuration of Pressure Release Mechanism

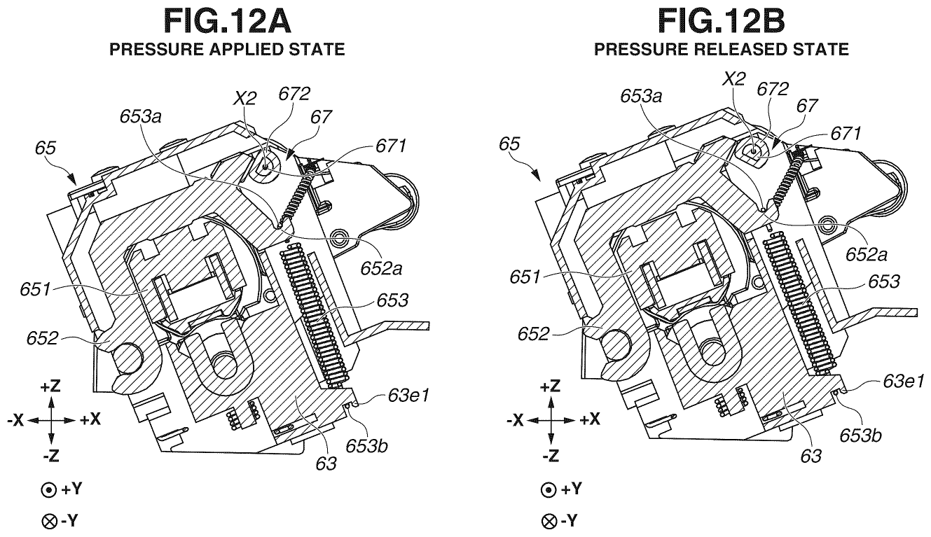

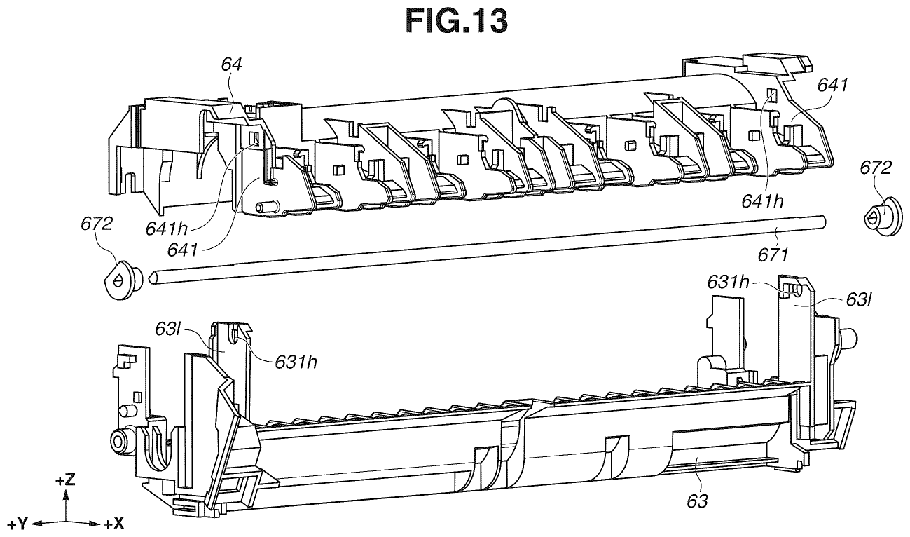

A configuration of a pressure release mechanism provided in the fixing unit 6 will now be described with reference to FIGS. 12A, 12B, and 13.

FIGS. 12A and 12B are cross-sectional views of the fixing unit 6. FIG. 12A illustrates a pressurized state in which the pressure release mechanism 67 applies pressure. FIG. 12B illustrates a pressure-released state in which the pressure release mechanism 67 releases the applied pressure. FIG. 13 is an exploded perspective view of the upper frame 64, the lower frame 63, and a camshaft 671, in which some components, such as the heating unit 61 and the pressing rotation member 62, are not illustrated. The pressure release mechanism 67 is a nip pressure release mechanism that changes a nip pressure at the nip portion np1 between the heating unit 61 and the pressing rotation member 62. The pressure release mechanism 67 includes the camshaft 671 and cams 672.

As illustrated in FIGS. 12A and 12B, the camshaft 671 is rotatable around an axis X2. The camshaft 671 extends in the axial direction and is made of conductive metal. As illustrated in FIG. 13, the cams 672 are fixed to (supported by) the end of the camshaft 671 in the first axial direction and the end of the camshaft 671 in the second axial direction. The cams 672 are supported so as to rotate together with the camshaft 671. The cams 672 are provided on the end side of the lower frame 63 in the first axial direction and on the end side of the lower frame 63 in the second axial direction. The cam 672 provided on the end side of the lower frame 63 in the first axial direction and the cam 672 provided on the end side of the lower frame 63 in the second axial direction have substantially the same structure.

Each cam 672 presses the pressure arm 652 against the biasing force of the pressure spring 653. Thus, the cam 672 rotates to change the pressing force of the pressure arm 652 against the pressing rotation member 62 of the heating unit 61. The cam 672 is rotatable between a pressure application position illustrated in FIG. 12A and a pressure release position illustrated in FIG. 12B.

To release the pressurized state, the camshaft 671 is rotated, thereby rotating the cams 672. When the cams 672 rotate, the pressure arms 652 in contact with the cams 672 move away from the transmission members 651 in the direction opposite to the direction in which the stay 613 is pressed by the transmission members 651.

This configuration reduces pressure with which the heating unit 61 is pressed toward the pressing rotation member 62.

A support configuration of the camshaft 671 will now be described with reference to FIG. 13. The lower frame 63 has support walls 63l that rotatably support the camshaft 671. The support walls 63l extend in a vertical direction (a Z direction). The support walls 63l have holes 631h that rotatably support the camshaft 671. The camshaft 671 runs through the holes 631h. Thus, the support walls 63l can also be referred to as shaft support portions that support the camshaft 671. The support walls 63l are provided on the end side of the lower frame 63 in the first axial direction and on the end side of the lower frame 63 in the second axial direction. The support walls 63l have substantially the same holes 631h.

The upper frame 64 has support walls 641 that rotatably support the camshaft 671.

The support walls 641 extend in a vertical direction. The support walls 641 have holes 641h that rotatably support the camshaft 671. The camshaft 671 runs through the holes 641h. The support walls 641are provided on the end side of the upper frame 64 in the first axial direction and on the end side of the lower frame 63 in the second axial direction. The support walls 641 have substantially the same holes 641h.

### Grounding Configuration of Fixing Unit

A grounding configuration of the fixing unit 6 will now be described. The fixing unit 6 in the present embodiment has a grounding configuration for removing static electricity generated in the heating unit 61 of the fixing unit 6. Static electricity generated in the fixing unit 6 flows to the apparatus main body 2 via a static electricity remover 66.

### Static Electricity Remover

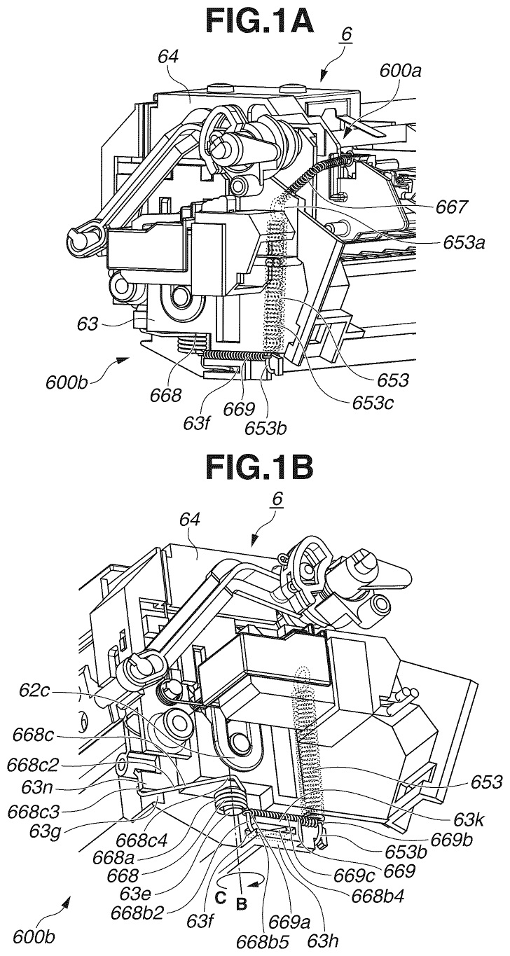

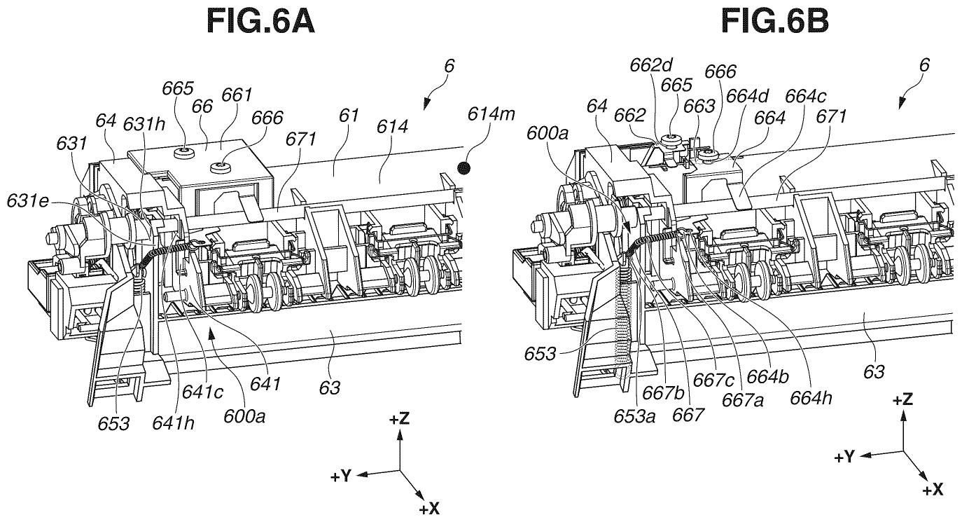

A configuration of the static electricity remover 66 will be described with reference to FIGS. 1A and 1B, 6A, and 6B, and 7 to 9. FIGS. 1A and 1B are perspective views of the fixing unit 6. FIG. 6A is a perspective view of the fixing unit 6. FIG. 6B is a perspective view of the fixing unit 6 in which the cover 661 illustrated in FIG. 6A is not visible.

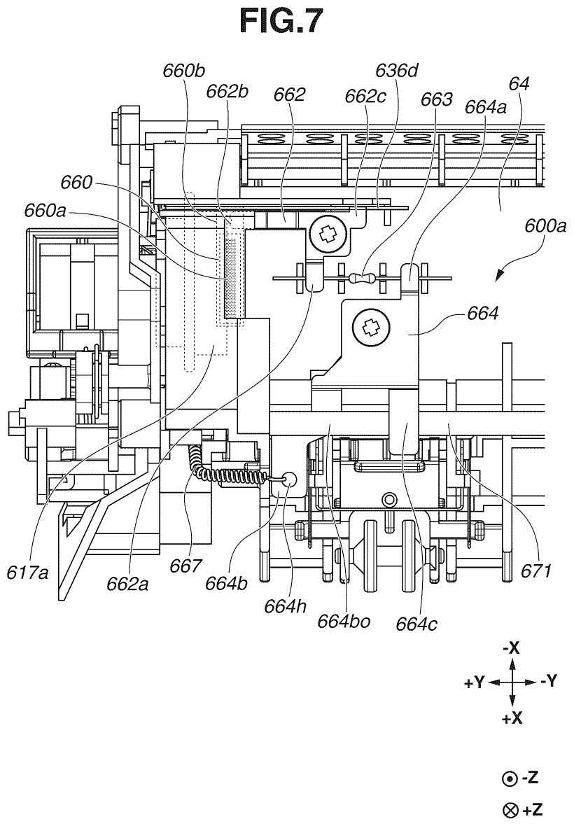

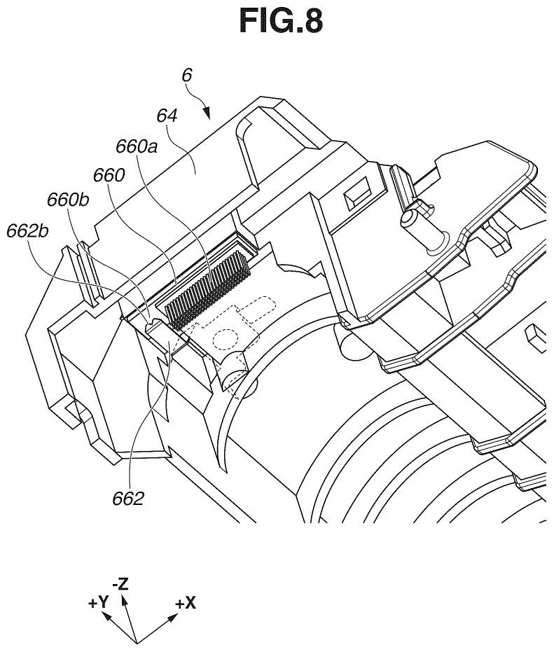

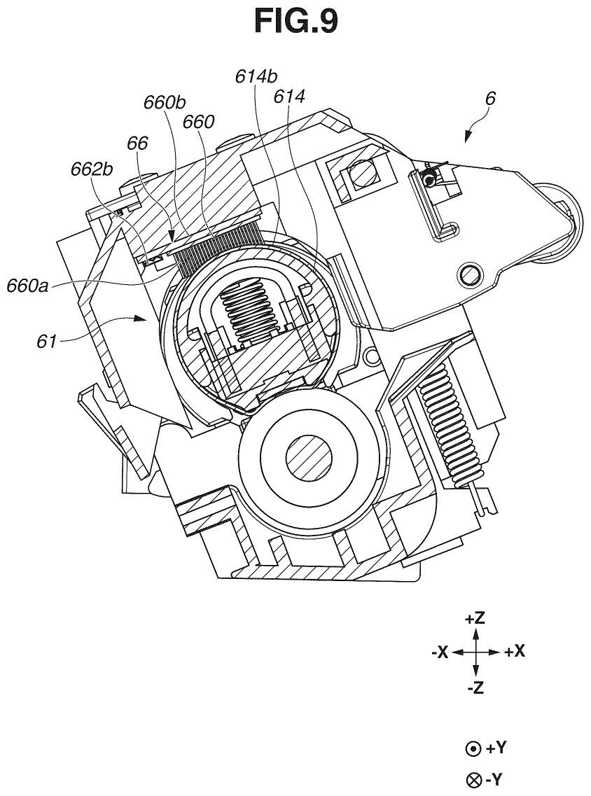

FIG. 7 is a top view of the fixing unit 6. FIG. 8 is a perspective view of the fixing unit 6. FIG. 9 is a cross-sectional view of the fixing unit 6.

As illustrated in FIG. 6A, the static electricity remover 66 for removing static electricity generated in the fixing unit 6 is attached to the upper frame 64. The static electricity remover 66 is positioned downstream of a midpoint 614m of the belt 614 in the first axial direction.

As illustrated in FIGS. 6A and 6B, and 7 to 9, the static electricity remover 66 includes a brush 660, a first conductive plate 662, a resistor 663, a second conductive plate 664, a cover 661, screws 665 and 666, and a first conductive spring 667.

The brush 660 is in contact with the heating unit 61 and the first conductive plate 662. The first conductive plate 662 is in contact with the resistor 663. The second conductive plate 664 is in contact with the first conductive spring 667. The brush 660, the first conductive plate 662, the resistor 663, and the second conductive plate 664 have electroconductivity. Thus, the static electricity generated in the heating unit 61 is transmitted from the brush 660 to the first conductive spring 667.

The cover 661 covers the brush 660, the first conductive plate 662, and the second conductive plate 664 from above. As illustrated in FIGS. 6A and 6B, the screw 665 fixes the first conductive plate 662 together with the cover 661 to the upper frame 64. The screw 666 fixes the second conductive plate 664 together with the cover 661 to the upper frame 64.

A configuration of the brush 660 (a brush member) will be described. As illustrated in FIG. 8, the brush 660 is fixed inside the upper frame 64. As illustrated in FIG. 9, the brush 660 is a conductive member that contacts the belt 614 from above. The brush 660 includes a brush body 660a and a base plate 660b. The brush body 660a is made of conductive resin. The base plate 660b is made of steel use stainless (SUS), which is a metal, and has electroconductivity. The brush body 660a is in contact with a surface 614b of the belt 614, and the brush body 660a and the belt 614 are electrically connected. Thus, the brush 660 and the heating unit 61 are electrically connected. In the present embodiment, the brush body 660a is in contact with the surface 614b of the belt 614. However, a conductive member may be arranged between the brush body 660a and the belt 614 to electrically connect the brush body 660a and the belt 614. The base plate 660b is a plate fixed to the brush body 660a and the upper frame 64. Thus, the brush body 660a is fixed to the upper frame 64 via the base plate 660b. As illustrated in FIG. 8, the base plate 660b is in contact with a contact portion 662b of the first conductive plate 662 described below. Thus, the base plate 660b and the first conductive plate 662 are electrically connected. As illustrated in FIG. 7, the brush body 660a is in contact with the transmission member 617a. More specifically, as viewed in a vertical direction (a Z direction), at least a portion of the brush body 660a overlaps the transmission member 617a in the first axial direction.

A configuration of the first conductive plate 662 will now be described. As illustrated in FIG. 7, the first conductive plate 662 is a conductive member positioned upstream of the brush 660 in the first axial direction. As illustrated in FIGS. 6A and 6B, a first hole 662d is formed in a portion of the first conductive plate 662, and the screw 665 runs through the first hole 662d. Thus, the first conductive plate 662 is fixed to (supported by) the upper frame 64 with the screw 665. As illustrated in FIG. 7, the first conductive plate 662 includes contact portions 662a, 662b, and 662c. The contact portion 662a is in contact with the resistor 663 described below. Thus, the first conductive plate 662 is electrically connected to the resistor 663. As illustrated in FIGS. 7 and 8, the contact portion 662b is in contact with the base plate 660b. In other words, the contact portion 662b and the base plate 660b are electrically connected. Since the first conductive plate 662 is electrically connected to the brush 660 and the resistor 663, static electricity can flow from the brush 660 to the resistor 663.

A configuration of the resistor 663 will now be described. The grounding configuration in the present embodiment includes the resistor 663. Gradually discharging the current to the ground via the resistor 663 makes it possible to prevent the protective layer formed on the surface of the heater 611 from being damaged. As illustrated in FIG. 7, the resistor 663 having a predetermined electrical resistance is pressed toward the upper frame 64 by the contact portion 662a of the first conductive plate 662 and a contact portion 664a of the second conductive plate 664 to be fixed to the upper frame 64.

The resistor 663 is in contact with the contact portion 662a, and the resistor 663 and the first conductive plate 662 are electrically connected. The resistor 663 is also in contact with the contact portion 664a of the second conductive plate 664 described below, and the resistor 663 and the second conductive plate 664 are electrically connected. Since the resistor 663 is electrically connected to the first conductive plate 662 and the second conductive plate 664, static electricity can flow from the first conductive plate 662 to the second conductive plate 664.

A configuration of the second conductive plate 664 will now be described. As illustrated in FIGS. 6A and 6B, a second hole 664d is formed in the second conductive plate 664, and the screw 666 runs through the second hole 664d. Thus, the second conductive plate 664 is fixed to the upper frame 64 with the screw 665.

As illustrated in FIG. 7, the second conductive plate 664 is a conductive member and includes the contact portion 664a, and contact portions 664b and 664c. The contact portion 664a is in contact with the resistor 663.

The resistor 663 and the second conductive plate 664 are electrically connected. A third hole 664h is formed in the contact portion 664b. A hook 667a of the first conductive spring 667 described below passes through the third hole 664h and engages with the contact portion 664b. The contact portion 664b is in contact with the hook 667a of the first conductive spring 667 described below. In other words, the second conductive plate 664 and the first conductive spring 667 are electrically connected. Since the second conductive plate 664 is electrically connected to the resistor 663 and the first conductive spring 667, static electricity can flow from the resistor 663 to the first conductive spring 667.

As illustrated in FIG. 7, as viewed in a vertical direction, the contact portion 664b has an overlap portion 664bo that overlaps the camshaft 671. The overlap portion 664bo is positioned below the camshaft 671. By arranging the second conductive plate 664 below the camshaft 671 in this manner, the rotational operation of the camshaft 671 is less likely to interfere with the second conductive plate 664 compared with a configuration in which the second conductive plate 664 is arranged above the camshaft 671.

The contact portion 664c is in contact with the camshaft 671 from above. That is, the contact portion 664c is a camshaft contact portion. This configuration makes it possible to release the electric charge on the camshaft 671 via the second conductive plate 664.

A configuration of the first conductive spring 667 will now be described. The first conductive spring 667 is a conductive member. As illustrated in FIGS. 6A and 6B, the first conductive spring 667 has a main body spring 667c and the hook 667a and a hook 667b.

The hook 667a is one end of the first conductive spring 667, and the hook 667b is the other end of the first conductive spring 667. As described above, the hook 667a engages with the contact portion 664b through the third hole 664h. The hook 667b engages with an upper hook 653a of the pressure spring 653 described below. In other words, the first conductive spring 667 is in contact with and electrically connected to both the second conductive plate 664 and the pressure spring 653. The main body spring 667c extends from the hook 667a in the first axial direction and connects to the hook 667b. Thus, the first conductive spring 667 (a first spring) extends in the rotational axis line direction of the pressure arm 652 and is electrically connected to the pressure spring 653.

The positional relationship between the main body spring 667c and the frame will now be described with reference to FIG. 6A. Each support wall 641 of the upper frame 64 has a groove shape 641c formed therein. The groove shape 641c allows the main body spring 667c to pass from upstream to downstream of the support wall 63l in the first axial direction. The first conductive spring 667 passes through the groove shape 641c and extends in the first axial direction.

The end of each support wall 63l of the lower frame 63 in the recording material conveying direction will be referred to as a downstream support end 631e. As illustrated in FIG. 6A, the downstream support end 631e is positioned between the camshaft 671 and the first conductive spring (the first spring) 667 in the recording material conveying direction. The downstream support end 631e comes in contact with the first conductive spring 667 to guide the first conductive spring 667 so as to restrict the movement of the first conductive spring 667 in a direction toward the camshaft 671. This configuration reduces the possibility that the rotation of the camshaft 671 will interfere with the first conductive spring 667. In the present embodiment, the first conductive spring 667 is configured to contact the downstream support end 631e. However, the first conductive spring 667 may be arranged further downstream of the downstream support end 631 in the recording material conveying direction, so that the first conductive spring 667 does not contact the downstream support end 631e.

A conductive configuration of the pressure spring 653 will now be described with reference to FIGS. 1A and 1B, 7, and 12A, and 12B. The pressure spring 653 includes the upper hook 653a, a lower hook 653b, and the main body spring 653c. One end of the pressure spring 653 is the upper hook 653a, and the other end is the lower hook 653b. The main body spring 653c is connected to the upper hook 653a and the lower hook 653b, and extends downward (vertically). It can be said that the pressure spring 653 extends downward from the upper hook 653a to the lower hook 653b. The upper hook 653a engages with the hook 667b of the first conductive spring 667. A hook 669b of a second conductive spring 669 described below engages with the lower hook 653b. Thus, the pressure spring 653 is in contact with and electrically connected to both the first conductive spring 667 and the second conductive spring 669.

As illustrated in FIGS. 12A and 12B, the pressure arm 652 includes an arm to-be-engaged portion 652a as a groove portion. The upper hook 653a is supported by engaging with the arm to-be-engaged portion 652a. In other words, the pressure spring 653 is in contact with and supported by the pressure arm 652. The lower frame 63 includes a frame to-be-engaged portion 63e1 as a groove portion. The lower hook 653b is engaged with and supported by the frame to-be-engaged portion 63e1.

A conductive configuration of the second conductive spring 669 will be described with reference to FIGS. 1A and 1B. The second conductive spring 669 has hooks 669a and 669b, and a main body spring 669c. One end of the second conductive spring 669 is the hook 669a, and the other end is the hook 669b. The main body spring 669c is connected to the hooks 669a and 669b. The second conductive spring 669 extends in the recording material conveying direction from the hook 669a to the hook 669b. The hook 669a engages with a contact spring 668, as described below. As described above, the hook 669b engages with the lower hook 653b. Thus, the second conductive spring 669 is in contact with and electrically connected to both the pressure spring 653 and the contact spring 668.

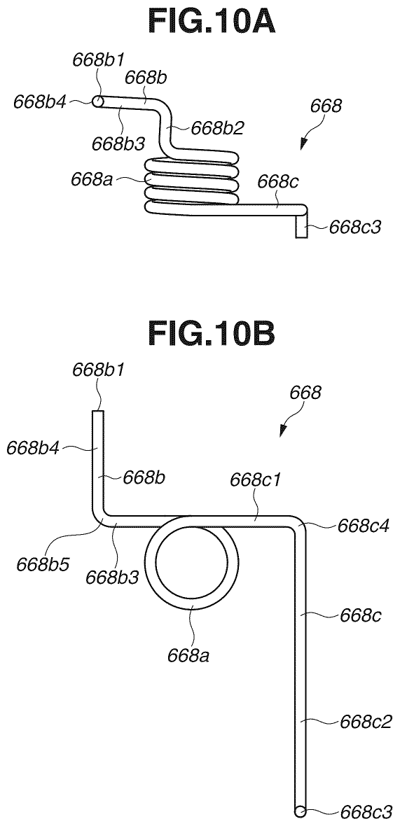

A conductive configuration of the contact spring 668 will now be described with reference to FIGS. 1A and 1B, and 10A, and 10B. FIG. 10A is a front view of the contact spring 668. FIG. 10B is a top view of the contact spring 668.

The contact spring 668 is a torsion coil spring composed of a single metal wire. The contact spring 668 has a coil portion 668a, a first arm 668b extending from one end of the coil portion 668a, and a second arm 668c extending from the other end in a direction different from that of the first arm 668b. The first arm 668b has a spring engagement portion 668b2, an extension portion 668b3, a hook portion 668b4, a bent portion 668b5, and an electrical contact 668b1 at the end that contacts a main body conductor portion 2A of the apparatus main body 2 described below. By the electrical contact 668b1 coming into contact with the main body conductor portion 2A, static electricity flows from the fixing unit 6 toward the apparatus main body 2.

The spring engagement portion 668b2 extends from one end of the coil portion 668a in the axial direction of the coil portion 668a. The extension portion 668b3 is bent from the spring engagement portion 668b2 and extends in a direction intersecting the axial direction of the coil portion 668a. The hook portion 668b4 is bent from the extension portion 668b3 at the bent portion 668b5 and extends in a direction orthogonal to the axial direction of the coil portion 668a. The electrical contact 668b1 is the end of the first arm 668b, and is formed as cut without any rounding or the like, and has a sharp edge. FIGS. 10A and 10B illustrate the electrical contact 668b1 as a metal wire neatly cut at a right angle, but the electrical contact 668b1 may have an irregular shape, such as a shape reflecting the shape of a cutting tool blade.

The second arm 668c has a second extension portion 668c1, a third extension portion 668c2, a retaining portion 668c3, and a to-be-pressed portion 668c4. The second extension portion 668c1 extends from the other end of the coil portion 668a in a direction intersecting the axial direction of the coil portion 668a. The to-be-pressed portion 668c4 is bent from the second extension portion 668c1 to the third extension portion 668c2. The third extension portion 668c2 extends in a direction orthogonal to the axial direction of the coil portion 668a and different from that of the second extension portion 668c1. The retaining portion 668c3 extends in the axial direction of the coil portion 668a from the end of the third extension portion 668c2 farther from the coil portion 668a.

The hook 669a on one end of the second conductive spring 669 engages with the spring engagement portion 668b2. The second conductive spring 669 is a tension spring. The hook 669b on the other end of the second conductive spring 669 engages with the lower hook 653b of the pressure spring 653. With this configuration, as illustrated in FIGS. 1A and 1B, the contact spring 668 is biased by the second conductive spring 669 to rotate around an axis B of a boss 63e (in the direction of an arrow C).

When the fixing unit 6 is not attached to the apparatus main body 2, the bent portion 668b5 of the first arm 668b abuts against an abutment surface 63f provided on the lower frame 63 by the biasing force of the second conductive spring 669, so that the orientation of the bent portion 668b5 is determined. The lower frame 63 has a first protective wall 63h positioned on one side of the hook portion 668b4 in the axial direction b of the coil portion 668a, and a second protective wall 63k positioned on the other side of the hook portion 668b4. In other words, the hook portion 668b4 is positioned in a gap between the first protective wall 63h and the second protective wall 63k. In this case, the electrical contact 668b1 does not protrude or protrudes only slightly from the first protective wall 63h and the second protective wall 63k. With this configuration, when the fixing unit 6 is not attached to the apparatus main body 2, the electrical contact 668b1 is protected by the first protective wall 63h and the second protective wall 63k, and is less likely to become caught on other objects.

On the other hand, when the fixing unit 6 is not attached to the apparatus main body 2, the to-be-pressed portion 668c4 is bent so as to protrude from the lower frame 63. The lower frame 63 has a slit 63g and a retaining wall 63n downstream of the boss 63e in the direction opposite to the recording material conveying direction. The slit 63g extends in a direction orthogonal to the axis of the boss 63e. More specifically, the slit 63g extends in the recording material conveying direction. The retaining wall 63n is arranged adjacent to the slit 63g. The third extension portion 668c2 of the second arm 668c enters the slit 63g. The retaining portion 668c3 is positioned upstream of the retaining wall 63n in the first axial direction and faces the retaining wall 63n. With this configuration, when the second conductive spring 669 rotates in the direction of the arrow C, i.e., the direction in which the to-be-pressed portion 668c4 protrudes, the retaining portion 668c3 abuts against the retaining wall 63n.

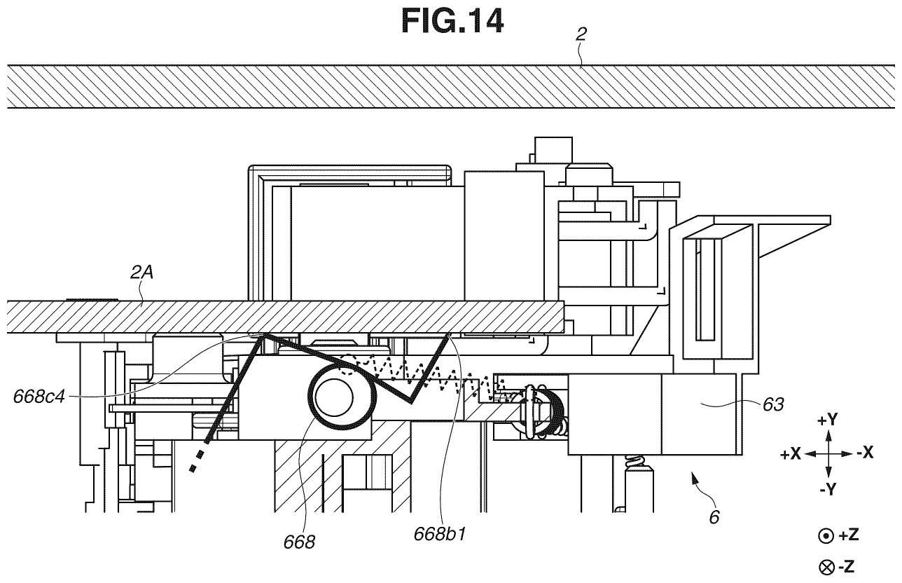

A conductive configuration of the apparatus main body 2 will now be described with reference to FIG. 14. FIG. 14 is a top view of the fixing unit 6. The apparatus main body 2 includes a main body conductor portion 2A with electroconductivity. In the present embodiment, the main body conductor portion 2A is an electrode. The main body conductor portion 2A is a metal plate that also serves as a frame of the apparatus main body 2. The main body conductor portion 2A is capable of electrical grounding. The main body conductor portion 2A is in contact with and electrically connected to the electrical contact 668b1. Thus, static electricity flowing from the main body conductor portion 2A to the electrical contact 668b1 can be flown to the ground.

The grounding configuration of the fixing unit 6 has been described. As described above, the brush body 660a is in contact with the surface 614b of the belt 614, and the brush body 660a and the belt 614 are electrically connected. The brush 660 is in contact with and electrically connected to the first conductive plate 662. The resistor 663 is in contact with and electrically connected to the second conductive plate 664. The second conductive plate 664 in contact with and electrically connected to the first conductive spring 667. The first conductive spring 667 in contact with and electrically connected to the pressure spring 653. The pressure spring 653 in contact with and electrically connected to the second conductive spring 669. The second conductive spring 669 in contact with and electrically connected to the contact spring 668. The electrical contact 668b1 of the contact spring 668 is in contact with and electrically connected to the main body conductor portion 2A of the apparatus main body 2. The main body conductor portion 2A is capable of electrical grounding.

The first conductive plate 662, the resistor 663, the second conductive plate 664, and the pressure spring 653 can be collectively referred to as a first conductor portion 600a. In other words, the first conductor portion 600a includes the first conductive plate 662, the resistor 663, the second conductive plate 664, and the first conductive spring 667 (the first spring).

The first conductor portion 600a contacts both the brush 660 (the brush member) and the pressure spring 653 to electrically connect the brush 660 (the brush member) and the pressure spring 653.

The second conductive spring 669 and the contact spring 668 can be collectively referred to as a second conductor portion 600b. In other words, the second conductor portion 600b includes the second conductive spring 669 and the contact spring 668. The second conductor portion 600b contacts both the pressure spring 653 and the main body conductor portion 2A to electrically connect the pressure spring 653 and the main body conductor portion 2A.

Consequently, the electric charge generated on the heating unit 61 is discharged to the ground via the brush 660, the first conductor portion 600a, and the second conductor portion 600b. With this configuration, the electric charge in the heating unit 61 can be removed.

In the fixing unit 6 of the present embodiment, since the upper frame 64 and the lower frame 63 are made of resin, it is difficult to use the upper frame 64 and the lower frame 63 as parts of the grounding configuration. However, as described above, the electric charge generated in the heating unit 61 can be released by electrically connecting the fixing unit 6 to the main body conductor portion 2A via the brush 660, the first conductor portion 600a, and the second conductor portion 600b.

In the fixing unit 6 of the present embodiment, the upper frame 64 (the second frame) supports the first conductive plate 662, the resistor 663, and the second conductive plate 664. Thus, it can be said that the upper frame 64 supports the first conductor portion 600a. It can also be said that the upper frame 64 guides the first conductor portion 600a. Supporting the first conductor portion 600a by the upper frame 64 in this manner makes it possible to improve stability of the first conductor portion 600a against external forces.

### First Modification

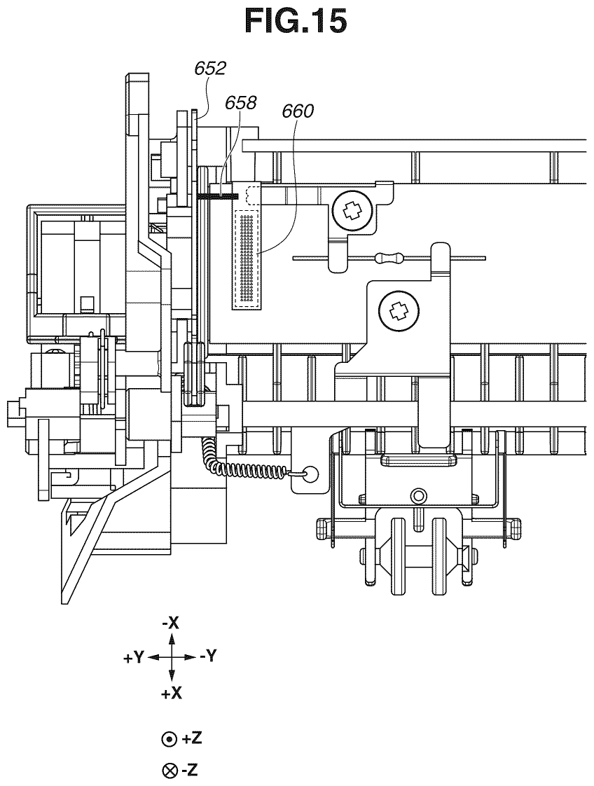

A first modification will now be described with reference to FIG. 15. FIG. 15 is a top view of a fixing unit 6. In the first embodiment, the grounding configuration is provided so that static electricity is released through the brush 660, the first conductor portion 600a, and the second conductor portion 600b. However, a pressure arm 652 may be a part of the grounding configuration. The pressure arm 652 may be made of a conductive member, and a brush 660, the pressure arm 652, and a pressure spring 653 may be electrically connected. In this case, the grounding configuration from the pressure spring 653 to the main body conductor portion 2A is the same as in the first embodiment. Thus, the description thereof is incorporated by reference without being repeated.

The fixing unit 6 includes an intermediate conductor portion 658 having electroconductivity. The intermediate conductor portion 658 is a metal member, but may be any member having electroconductivity. As illustrated in FIG. 15, the intermediate conductor portion 658 is in contact with and electrically connected to the brush 660 and the pressure arm 652. In the present modification, the intermediate conductor portion 658 is in contact with and electrically connected to the belt 614 via the brush 660. This allows stable contact with the belt 614 with weak force so as not to damage the belt 614.

The intermediate conductor portion 658 may directly contact the belt 614 to electrically connect the intermediate conductor portion 658 and the belt 614 without providing the brush 660. In this case, since the brush 660 is not provided, a grounding configuration can be implemented at low cost. The intermediate conductor portion 658 is separate from a transmission member 617 or the pressure arm 652, but the intermediate conductor portion 658 may be integrated with the transmission member 617 or the pressure arm 652.

The transmission member 617 illustrated in FIG. 5 may be made of a conductive material without providing the intermediate conductor portion 658. In this case, the transmission member 617 is in contact with and electrically connected to both the belt 614 and the pressure arm 652.

### Second Modification

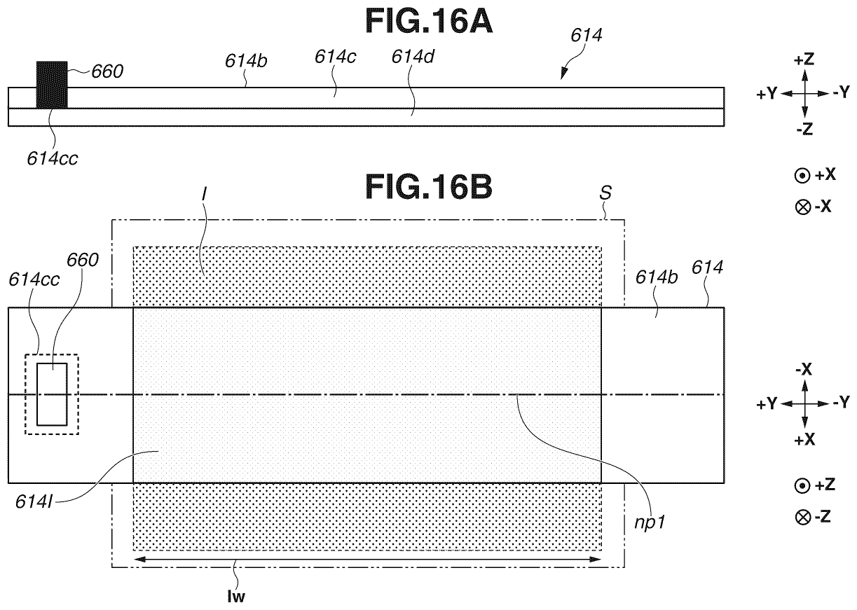

A second modification will be described with reference to FIGS. 16A and 16B. FIGS. 16A and 16B are schematic diagrams each illustrating a part of a belt 614. A surface 614b of the belt 614 with which a brush body 660a is in contact may be a coating layer of fluororesin or the like, but if the belt 614 is made with a conductive material, such as a metal sleeve, the coating layer may be partially removed to expose the metal layer (a conductive layer).

As illustrated in FIG. 16A, the belt 614 includes a conductive layer 614d and an insulating layer 614c that covers the conductive layer 614d. For example, the conductive layer 614d is a base layer of the belt 614. The conductive layer 614d includes an exposed portion 614cc that is not covered with the insulating layer 614c so that the conductive layer 614d is exposed toward the outer surface of the belt 614. The brush 660 is in contact with the exposed portion 614cc, which releases the electric charge of a heating unit 61 to the ground through the above-described grounding configuration.

FIG. 16B illustrates a state where a sheet S is positioned at a nip portion np1 and a toner image is fixed by the fixing unit 6. FIG. 16B illustrates a case where a toner image I formed on the sheet S has the largest size in a generatrix direction (Y) of the belt 614. The portion of the belt 614 at the same position as the toner image I in the generatrix direction (Y) of the belt 614 will be referred to as a belt first portion 614I. At least a part of the exposed portion 614cc is positioned outside the belt first portion 614I in the generatrix direction of the belt 614. Similarly, at least a part of the brush 660 is positioned outside the belt first portion 614I in the generatrix direction of the belt 614. Configuring the exposed portion 614cc in this manner makes it possible to reduce the impact on the fixing quality compared with a configuration in which the exposed portion 614cc is positioned at the same position as the belt first portion 614I in the generatrix direction of the belt 614.

As above, the first embodiment and the first and second modifications have been described. In the present embodiment, the brush body 660a is made of conductive resin. However, this is not necessarily required. Any material, such as a brush made of a thin metal, a weak-torsion coil spring, or a thin metal foil, may be used that has electroconductivity and can stably contact the belt 614 with weak force so as not to damage the belt 614.

According to the present disclosure, a fixing apparatus in a new form that has advanced a conventional technology.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-173031, filed Oct. 2, 2024, which is hereby incorporated by reference herein in its entirety.

What is claimed is:

1. A fixing apparatus configured to be installed in an image forming apparatus to fix toner to a recording material, the image forming apparatus including a main body conductor portion capable of electrical grounding, the fixing apparatus comprising:
a heating unit including an endless belt and a heater that is disposed inside the belt to heat the belt;
a pressure roller configured to form a nip portion together with the heater via the belt;
a pressure arm configured to press the heating unit against the pressure roller;
a pressure spring configured to bias the pressure arm to press the heating unit against the pressure roller, the pressure spring having electroconductivity;
a frame configured to support the heating unit and made of resin;
a brush member configured to contact the belt and that has electroconductivity;
a first conductor portion configured to contact and electrically connect the brush member and the pressure spring; and
a second conductor portion configured to contact and electrically connect the pressure spring and the main body conductor portion.

2. The fixing apparatus according to claim 1, wherein the first conductor portion includes a resistor.

3. The fixing apparatus according to claim 1,
wherein the belt includes a conductive layer and an insulating layer that covers the conductive layer,
wherein the conductive layer has an exposed portion that is not covered with the insulating layer so as to be exposed toward the outside of the belt;
wherein the brush member is in contact with the exposed portion of the conductive layer,
wherein a nip portion is formed by the pressure roller, the heater, and the belt,
wherein, in a case where the recording material is positioned at the nip portion and a toner image formed on the recording material has a largest size in a generatrix direction of the belt, a portion of the belt that is at the same position as the toner image in the generatrix direction is a belt first portion, and
wherein at least a part of the exposed portion is positioned outside the belt first portion in the generatrix direction.

4. The fixing apparatus according to claim 1, further comprising:
a camshaft rotatably supported by the frame; and
a cam supported by the camshaft and configured to rotate with the camshaft, to change a pressing force of the pressure arm to the pressure roller.

5. The fixing apparatus according to claim 4, wherein, as viewed in a vertical direction, the first conductor portion has an overlap portion that overlaps the camshaft, with the overlap portion being positioned below the camshaft.

6. The fixing apparatus according to claim 4, further comprising:
a second frame that is made of resin, wherein:
the second frame is configured to support the camshaft in a case where the frame is a first frame,
the first frame is made of resin, and
the pressure spring and the brush member are conductive.

7. The fixing apparatus according to claim 6, wherein the first conductor portion is supported by the second frame.

8. The fixing apparatus according to claim 1,
wherein the first conductor portion includes a first spring, and
wherein the first spring extends in a rotational axis direction of the pressure arm and is electrically connected to the pressure spring.

9. The fixing apparatus according to claim 4,
wherein the first conductor portion includes a first spring,
wherein the frame supports the camshaft and includes a shaft support portion extending in a vertical direction,
wherein a nip portion is formed by the pressure roller, the heater, and the belt,
wherein in a case where a direction in which the recording material is conveyed at the nip portion is defined as a recording material conveying direction, a downstream end of the shaft support portion in the recording material conveying direction is a downstream support end, and
wherein the downstream support end is positioned between the camshaft and the first spring in the recording material conveying direction.

10. The fixing apparatus according to claim 9, wherein the downstream end of the shaft support portion restricts movement of the first spring in a direction approaching the camshaft.

11. The fixing apparatus according to claim 3, wherein the conductive layer is a base layer of the belt.

12. The fixing apparatus according to claim 1,
wherein the second conductor portion includes a torsion coil spring, and
wherein the torsion coil spring contacts the main body conductor portion.

13. The fixing apparatus according to claim 1, wherein the main body conductor portion is an electrode.

14. The fixing apparatus according to claim 4, wherein the first conductor portion includes a camshaft contact portion that contacts the camshaft.

15. The fixing apparatus according to claim 1,
wherein a nip portion is formed by the pressure roller, the heater, and the belt,
wherein a direction in which the heating unit conveys the recording material positioned at the nip portion is a recording material conveying direction,
wherein the frame includes an upper guide surface positioned downstream of the heating unit in the recording material conveying direction, and
wherein the upper guide surface guides an upper surface of the recording material conveyed in the recording material conveying direction.

16. A fixing apparatus that is attached to an apparatus main body of an image forming apparatus to fix toner to a recording material, the image forming apparatus including a main body conductor portion capable of electrical grounding, the fixing apparatus comprising:
a heating unit including an endless belt and a heater to heat inside the belt;
a pressure roller configured to form a nip portion together with the heater via the belt;
a conductive pressure arm configured to press the heating unit against the pressure roller;
a conductive pressure spring configured to contact the pressure arm and to bias the pressure arm towards press against the heating unit;
a frame made of resin and configured to support the heating unit;
a conductive brush member configured to contact the belt;
an intermediate conductor portion configured to contact both the brush member and the pressure arm to electrically connect the brush member and the pressure arm; and
a conductor portion configured to contact both the pressure spring and the main body conductor portion to electrically connect the pressure spring and the main body conductor portion.
